(19) United States
(12) Patent Application Publication
(10) Pub. No.: US 2007/0164717 A1
(43) Pub. Date: Jul. 19, 2007

(54) Power factor improving circuit and switching power supply

(75) Inventor: Syohei Osaka, Saitama (JP)

Correspondence Address: OBLON, SPIVAK, MCCLELLAND, MAIER & NEUSTADT, P.C., 1940 DUKE STREET, ALEXANDRIA, VA, 22314, US

(73) Assignee: SANKEN ELECTRIC CO., LTD., SAITAMA (JP)

(21) Appl. No.: 11/579,410

(22) PCT Filed: Apr. 11, 2005
(86) PCT No.: PCT/JP05/07030

§ 371 Date: Nov. 2, 2006

(30) Foreign Application Priority Data
May 7, 2004 (JP) P2004-138362

(51) Int. Cl. G05F 1/00

(52) U.S. Cl. 323/282

(57) ABSTRACT

A switching power device includes a control circuit 20 that inputs output voltage from a voltage detecting terminal a and turns ON/OFF a switching element Q1 on a basis of the output voltage, detection holding means 23, 24 that detect an abnormality when it occurs in a power-factor improvement circuit, stop an operation of the switching element and output a holding signal while holding a stopped condition of the switching element, abnormal operating signal outputting means 30 that outputs an abnormal operating signal in the form of voltage more than a predetermined voltage to the voltage detecting terminal a on the basis of the holding signal from the detection holding means 23, 24, and abnormal signal detecting means 40 that outputs an abnormal signal to a load circuit 10 upon detecting that a potential of the voltage detecting terminal a has reached voltage more than the predetermined voltage on the basis of the abnormal operating signal from the abnormal operating signal outputting means 30.

### TECHNICAL FIELD

The present invention relates to a power-factor improvement circuit having an abnormality communicating function to improve safety of the circuit at an abnormality and a switching power device having this power-factor improvement circuit and a load circuit, such as DC/DC converter.

### BACKGROUND OF ART

FIG. 1 shows a circuit diagram of a conventional switching power device. This switching power device includes a power-factor improvement circuit and a load circuit 10, such as DC/DC converter, connected to this power-factor improvement circuit. The power-factor improvement circuit improves a power factor of an A.C. power source 1 by firstly inputting rectified voltage, which has been obtained by rectifying alternator voltage of the A.C. power source 1 by a full-wave rectifying circuit 2, into a series circuit having a reactor 3, a switching element Q1 and a current detecting resistor 5 and secondly turning on/off the switching element Q1 through a control circuit 20a. Additionally, the power-factor improvement circuit provides direct-current (D.C.) output voltage by a diode 6 and a smoothing capacitor 8. Note that in the power-factor improvement circuit, there exist an average-current mode type circuit and a peak-current mode type circuit. Here, we explain an example of using the average-current mode type power-factor improvement circuit.

A diode 4 is connected to both terminals (between drain and source) of the switching element Q1. Further, a series circuit having a diode 6 and a smoothing capacitor 9 is connected to the terminals of the switching element Q1 A load circuit 10 is connected to both terminals of the smoothing capacitor 9. Further, a series circuit having a resistor 7 and a resistor 8 is connected to the terminals of the smoothing capacitor 9.

The control circuit 20a consists of an integrated circuit (IC) and comprises control means 21, output voltage detecting means 22, overvoltage detecting means 23 and a latch circuit 24. The control means 21 controls to turn ON/OFF the switching element Q1 thereby improving the power factor of the A.C. power source 1. For instance, the control means 21 comprises a multiplier 211, current detecting means 212 and a pulse-width modulator 213. The current detecting resistor 5 serves to detect current flowing in the reactor 3.

The output-voltage detecting means 22 inputs voltage at a voltage detecting terminal a, the voltage being obtained by separating by the resistors 7 and 8, magnifies an error between the voltage at the voltage detecting terminal a and a reference voltage thereby producing an error voltage and outputs it to the multiplier 211. The multiplier 211 multiplies the error voltage from the output voltage detecting means 22 by a full-wave rectified voltage from the full-wave rectifying circuit 2 and outputs a resultant multiplied output voltage to the current detecting means 212.

The current detecting means 212 magnifies an error between a voltage proportional to an input current detected at the current detecting resistor 5 and the multiplied output voltage outputted from the multiplier 211 thereby generating an error voltage and outputs this error voltage to the pulse-width modulator 213, in the form of a comparison input signal.

The pulse-width modulator 213 inputs a triangular signal and the comparison input signal from the current detecting means 212. For instance, when the comparison input signal has a value equal to or more than a value of the triangular signal, the pulse-width modulator 213 generates an “ON” pulse signal. Conversely, when the comparison input signal has a value less than a value of the triangular signal, the pulse-width modulator 213 generates an “OFF” pulse signal. These “ON” and “OFF” pulse signals are impressed on a gate of the switching element Q1.

In detail, the full-wave rectified voltage obtained by the full-wave rectifying circuit 2 rectifying the input voltage (A.C. voltage) of the A.C. power source 1 has a sinusoidal waveform with respect to each half cycle. Inputting “half-cycle and sinusoidal-wave” voltage from the full-wave rectifying circuit 2 and the voltage from the output-voltage detecting means 22, the multiplier 211 multiplies these voltages by each other and outputs a resultant voltage where a magnitude of each sinusoidal wave is altered. Comparing the “half-cycle and sinusoidal-wave” voltage from the full-wave rectifying circuit 2 with the voltage generated by the input current, which is proportional to the current detecting resistor 5, the current detecting means 212 controls the input current so as to have a sinusoidal wave with respect to each half cycle. Thus, as the input current flowing in the current detecting resistor 5 can be reformed to have a sinusoidal wave with respect to each half cycle, which is similar to the input voltage of the A.C. power source 1, it is possible to improve the power factor of the power source.

Additionally, the control circuit 20a detects the voltage obtained by dividing by the resistors 7 and 8 at the voltage detecting terminal a and controls to turn ON/OFF the switching element Q1 so that the output voltage becomes constant on the basis of the detected voltage. Consequently, the load circuit 10 can be supplied with stable D.C. voltage.

Next, the operation of the so-constructed switching power device will be described. First, when the switching element Q1 is turned ON, the current flows in the course of the full-wave rectifying circuit 2, the reactor 3, the switching element Q1, the current detecting resistor 5 and again the full-wave rectifying circuit 2, in sequence Consequently, energy is stored in the reactor 3. This current increases with the passage of time linearly.

Next, when the switching element Q1 is changed from its ON state to the OFF state, the voltage of the switching element Q1 rises due to voltage induced in the reactor 3. The current flowing in the switching element Q1 becomes zero since the switching element Q1 is turned OFF. Consequently, with a flowage of current in the course of the reactor 3, the diode 6 and the smoothing capacitor 9 in sequence, the load circuit 10 is supplied with D.C. voltage.

Now, if the power-factor improvement circuit has an abnormality causing the output voltage to be raised for any reason, the voltage as a result of dividing by the resistor 7 and the resistor 8, namely, the voltage at the voltage detecting terminal a rises. Then, by detecting the voltage as a result of dividing by the resistors 7 and 8, the overvoltage detecting means 23 detects that the voltage has risen. Receiving an overvoltage detecting signal generated from the overvoltage detecting means 23, the control means 21 stops the operation of the switching element Q1 and simultaneously activates the latch circuit 24. Thus, the latch circuit 24 outputs a latch signal to maintain the stopped condition of the switching element Q1.

Additionally, even when the power-factor improvement circuit is overheated abnormally, overheat detecting means (not shown) detects that the circuit has been overheated abnormally and outputs an overheat detecting signal to the control means 21. Then, receiving the overheat detecting signal, the control means 21 stops the operation of the switching element Q1 and simultaneously activates the latch circuit 24. Thus, the latch circuit 24 outputs the latch signal to maintain the stopped condition of the switching element Q1.

Additionally, as shown in FIG. 1, the power-factor improvement circuit is normally formed by a boosting chopper circuit. Therefore, if the operation of the switching element Q1 is stopped, then the load circuit 10 is supplied with D.C. voltage as a result of rectifying and smoothing the A.C. voltage of the AC power source 1 by the full-wave rectifying circuit 2 and the smoothing capacitor 9.

In a related technology, Japanese Patent Publication Laid-open No.2003-264979 discloses a switching-power control semiconductor device. In this device, if a feedback signal for controlling the switching operation of the switching element cannot be obtained to produce no discharge of current from a control terminal, the switching operation is stopped and further, the so-stopped condition is held in order to prevent break-down of the switching power device.

In detail, as shown in FIG. 2, this device is provided with an opened control-terminal protection circuit 110. In operation if the feedback signal to the control terminal 126 is cut off to produce no discharge of current from the control terminal 126, the opened control-terminal protection circuit 110 operates to raise the voltage of the control terminal 126 to a determined voltage value thereby operating an overvoltage protection circuit 108. With the operation of the overvoltage protection circuit 108, the circuit 110 stops the switching operation and further maintains the so-stopped condition.

### DISCLOSURE OF THE INVENTION

In the power-factor improvement circuit of FIG. 1, however, even when the operation of the switching element Q1 is stopped owing to the protecting function of the latch circuit 24, the load circuit 10 is still supplied with voltage depending on the input voltage, as mentioned before. Now suppose that, as one generally-used example, the load circuit is operated on condition of A.C. 85V to A.C. 264V as the A.C. input voltage and 380V as the output voltage of the power-factor improvement circuit. In this case, when the power-factor improvement circuit operates normally, the potential difference at the smoothing capacitor 9 becomes D.C. 380V. On the contrary, if the operation of the power-factor improvement circuit is stopped, the potential difference of the smoothing capacitor 9 becomes approx. D.C. 140V in the A.C. input voltage of 100V or D.C. 280V in the A.C. input voltage of 200V.

Although the load circuit 10 connected to a subsequent stage of the power-factor improvement circuit does not work at D.C. 140V, it would sufficiently appear that the power-factor improvement circuit could work at D.C. 280V. In this way, depending on the input voltage, there is a possibility that the load circuit 10 does not stop but maintains its operation.

That is, in spite of an occurrence of any abnormality in the switching power device, there is a possibility that the switching power device continues to operate. Further, in case of high input voltage, the voltage at the smoothing capacitor 9 does not change so much irrespective of operation of the power-factor improvement circuit and therefore, it becomes difficult to confirm whether the power-factor improvement circuit is performing normally.

On the other hand, in the switching-power control semiconductor device of FIG. 2, when the feedback signal for the control terminal is cut off, it is carried out to elevate voltage thereby activating the overvoltage protecting circuit. Then, using the overvoltage protecting circuit in activation, it is further performed to stop the switching operation of the switching element and maintain its stopped condition. This measure corresponds to the following operations of the power-factor improvement circuit of FIG. 1 in case of abnormality: the overvoltage detecting means 23 detects a rise in voltage; the control means 21 stops the operation of the switching element Q1; and the latch circuit 24 holds the stopped condition of the switching element Q1. Therefore, in accordance with the technique shown in FIG. 2, it is impossible to stop the operation of the load circuit in the switching power device of FIG. 1 in spite of the possibility of bringing down the power-factor improvement circuit and subsequently maintaining the so-stopped condition.

In order to solve the above-mentioned problem, an object of the present invention is to provide a power-factor improvement circuit which can output an abnormal signal to a load circuit when the operation of the power-factor improvement circuit is stopped due to an occurrence of abnormality, and a switching power device which can stop the operation of the load circuit on receipt of the abnormal signal from the power-factor improvement circuit, thereby accomplishing safety improvement.

According to a first aspect of the present invention, there is provided a switching power device configured to convert input voltage into direct-current output voltage with ON/OFF operations of a switching element, comprising: control means that inputs the output voltage from a voltage detecting terminal thereby turning ON/OFF the switching element on a basis of the output voltage; detection holding means that detects an abnormality when it occurs in the switching power device to stop an operation of the switching element and that outputs a holding signal while holding a stopped condition of the switching element; and abnormal operating signal outputting means for outputting an abnormal operating signal in the form of voltage more than a predetermined voltage to the voltage detecting terminal, based on the holding signal from the detection holding means.

According to a second aspect of the present invention, there is also provided a power-factor improvement circuit configured to improve a power factor of an alternating-current power source by first inputting rectified voltage, which has been obtained by rectifying alternating-current power voltage of the alternating-current power source with a rectifying circuit, into a series circuit having a reactor and a switching element and secondly turning ON/OFF the switching element, and also configured to provide direct-current output voltage, the power-factor improvement circuit comprising: control means that inputs the output voltage from a voltage detecting terminal thereby turning ON/OFF the switching element on a basis of the output voltage; detection holding means that detects an abnormality when it occurs in the switching power device to stop an operation of the switching element and that outputs a holding signal while holding a stopped condition of the switching element; and abnormal operating signal outputting means for outputting an abnormal operating signal in the form of voltage more than a predetermined voltage to the voltage detecting terminal, based on the holding signal from the detection holding means.

According to a third aspect of the present invention, there is also provided a switching power device having a power-factor improvement circuit and a load circuit connected to the power-factor improvement circuit, the power-factor improvement circuit being configured to improve a power factor of an alternating-current power source by first inputting rectified voltage, which has been obtained by rectifying alternating-current power voltage of the alternating-current power source with a rectifying circuit, into a series circuit having a reactor and a switching element and secondly turning ON/OFF the switching element, and also configured to provide direct-current output voltage, wherein the power-factor improvement circuit comprises: control means that inputs the output voltage from a voltage detecting terminal thereby turning ON/OFF the switching element on a basis of the output voltage; detection holding means that detects an abnormality when it occurs in the switching power device to stop an operation of the switching element and that outputs a holding signal while holding a stopped condition of the switching element; abnormal operating signal outputting means for outputting an abnormal operating signal in the form of voltage more than a predetermined voltage to the voltage detecting terminal on the basis of the holding signal from the detection holding means; and abnormal signal detecting means configured to output an abnormal signal when detecting, on the basis of the abnormal operating signal from the abnormal operating signal outputting means, that the voltage detecting terminal has reached voltage more than the predetermined voltage.

### BRIEF DESCRIPTION OF THE DRAWINGS

FIG. 1 is a circuitry diagram showing a switching power device in accordance with a prior art example 1.

FIG. 2 is a circuitry diagram showing a switching power device in accordance with a prior art example 2.

FIG. 3 is a circuitry diagram showing a switching power device in accordance with an embodiment of the present invention.

FIG. 4 is a view showing a structural example 1 of abnormal operating signal outputting means provided in the switching power device in accordance with the embodiment of the present invention.

FIG. 5 is a view showing a structural example 2 of the abnormal operating signal outputting means provided in the switching power device in accordance with the embodiment of the present invention.

FIG. 6 is a view showing a structural example 3 of the abnormal operating signal outputting means provided in the switching power device in accordance with the embodiment of the present invention.

FIG. 7 is a view showing a structural example 1 of abnormal signal detecting means provided in the switching power device in accordance with the embodiment of the present invention.

FIG. 8 is a view showing a structural example 2 of the abnormal signal detecting means provided in the switching power device in accordance with the embodiment of the present invention.

FIG. 9 is a circuitry diagram of a DC/DC converter as a detailed example of a load circuit provided in the switching power device in accordance with the embodiment of the present invention.

### PREFERRED EMBODIMENTS FOR EMBODYING THE INVENTION

One embodiment of a switching power device related to the present invention will be described below in detail, with reference to drawings.

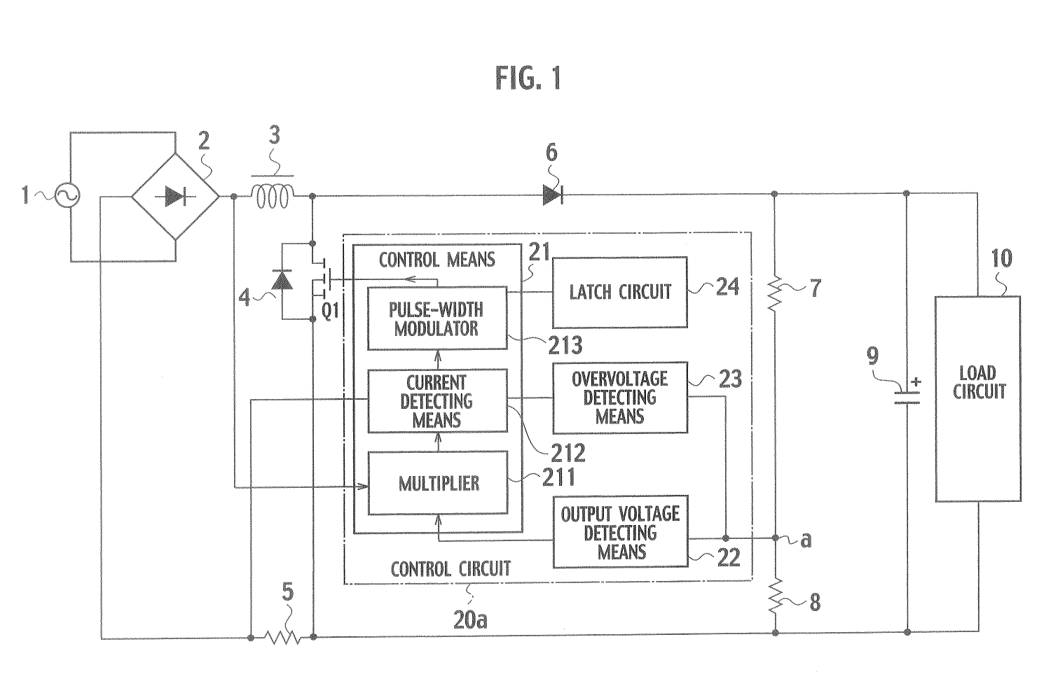

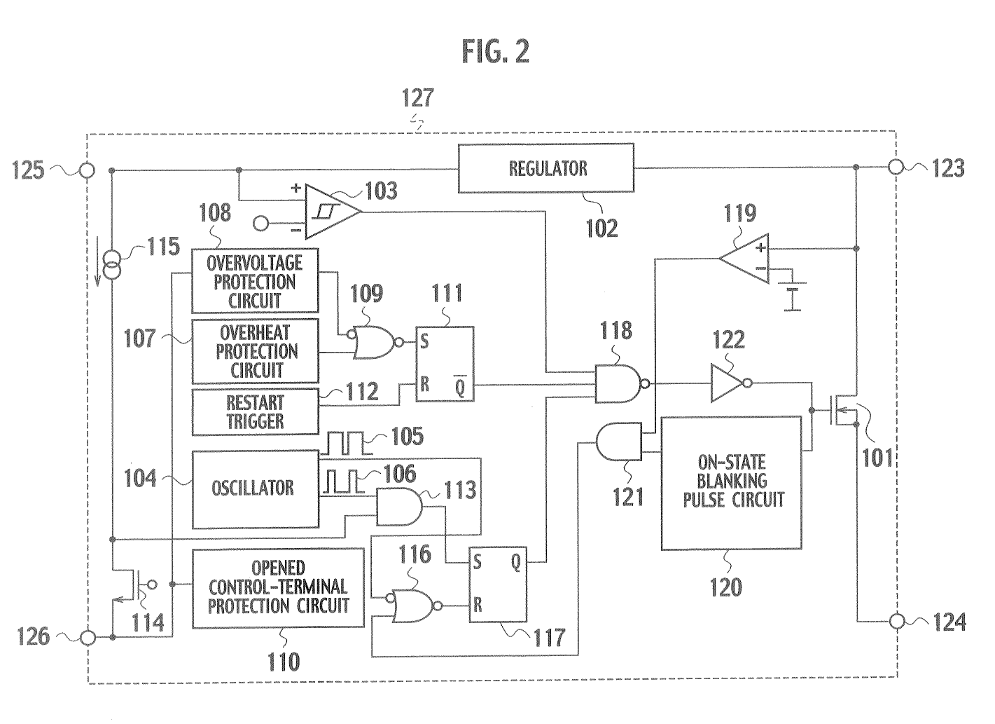

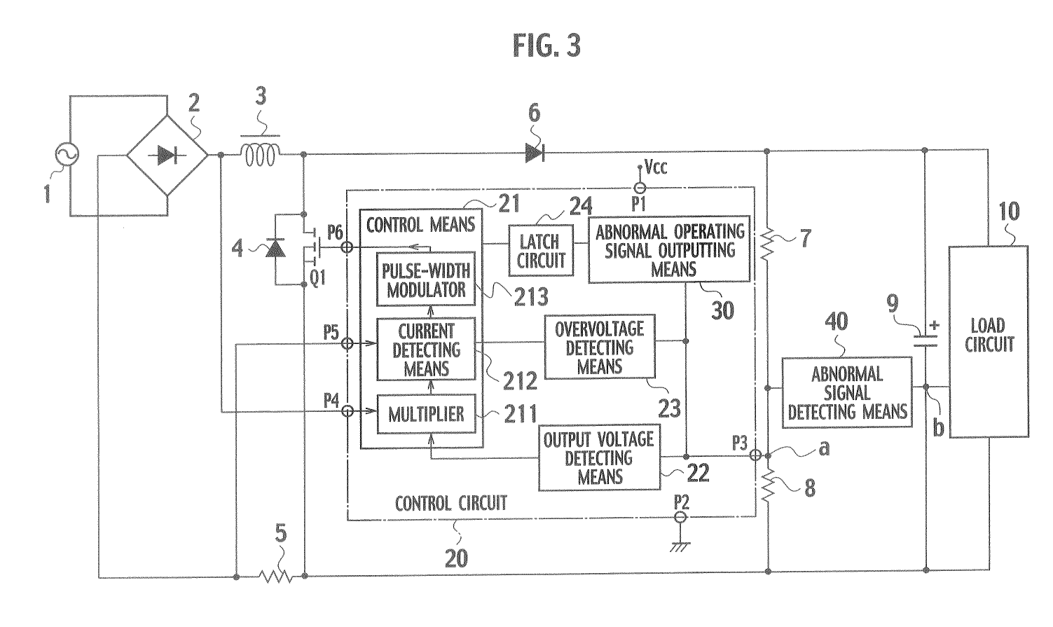

FIG. 3 is a circuitry diagram showing the switching power device in accordance with one embodiment of the present invention. This switching power device is characterized by further adding abnormal operating signal outputting means 30 and abnormal signal detecting means 40 to the switching power device of FIG. 1.

Note that the other constitution is identical to the constitution of the switching power device of FIG. 1. Therefore constituents identical to those of the switching power device of FIG. 1 are indicated with the same reference numerals respectively and their descriptions are eliminated.

The latch circuit 24 holds a stopped condition of the switching element Q1 and outputs a latch signal to the abnormal operating signal outputting means 30. The abnormal operating signal outputting means 30 is arranged in a control circuit 20 consisting of an integrated circuit (IC) and outputs an abnormal operating signal to a voltage detecting terminal a, in the form of a voltage more than a predetermined voltage, on the basis of the latch signal from the latch circuit 24.

Based on the abnormal operating signal from the abnormal operating signal outputting means 30, when it is detected that the voltage detecting terminal a has reached a voltage more than the predetermined voltage, the abnormal signal detecting means 40 outputs an abnormal signal to the load circuit 10 to inform the load circuit 10 of a situation that a power-factor improvement circuit has an abnormality. Based on the abnormal signal from the abnormal signal detecting means 40, the load circuit 10 stops its operation.

Next, the operation of the switching power device constructed above will be described. The device's operations up to the occurrence of abnormality of the power-factor improvement circuit and the latching operation are similar to those of the switching power device of FIG. 1 and therefore, their descriptions are eliminated that far.

First, due to the abnormality, the latch circuit 24 is operated to hold the stopped condition of the switching element Q1 and output the latch signal to the abnormal operating signal outputting means 30. On receipt of the latch signal, the abnormal operating signal outputting means 30 raises a potential of the voltage detecting terminal a up to a certain voltage more than the predetermined voltage and maintains this certain voltage.

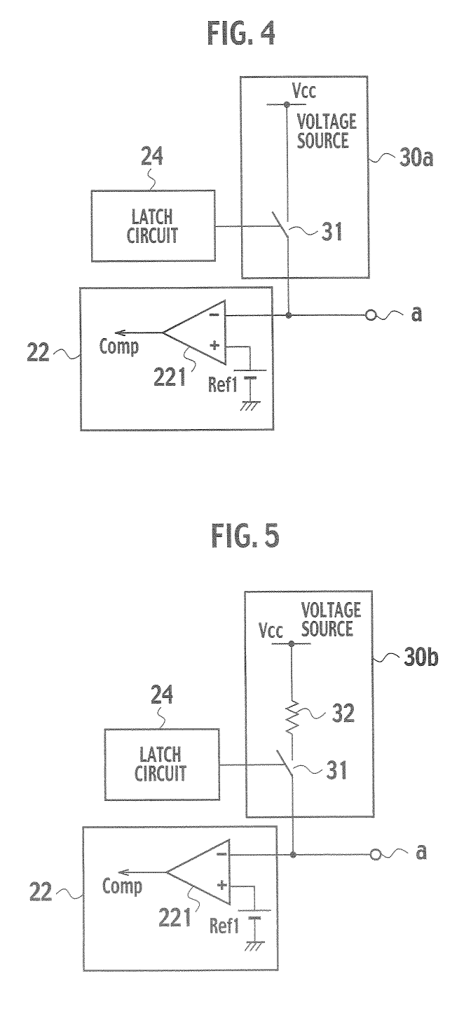

In detail, the abnormal operating signal outputting means 30 comprises circuitries shown in FIGS. 4 to 6. In an abnormal operating signal outputting means 30a shown in FIG. 4, a voltage source Vcc is connected to the voltage detecting terminal a through a switch 31, such as transistor When the power-factor improvement circuit becomes abnormal, the switch 31 is turned ON on receipt of the latch signal from the latch circuit 24, so that voltage from the voltage source Vcc is impressed on the voltage detecting terminal a, so that its potential rises. For the voltage source Vcc, there is available either a power supply voltage for driving the control circuit 20 or a reference voltage used in the control circuit 20, such as reference voltage as a foundation for producing a reference voltage Ref1 used for the output-voltage detecting means 22 having an error amplifier 221.

In an abnormal operating signal outputting means 30b shown in FIG. 5, the voltage source Vcc is connected to the voltage detecting terminal a through a current-limit resistor 32 and the switch 31. When the power-factor improvement circuit becomes abnormal, the switch 31 is turned ON on receipt of the latch signal from the latch circuit 24. As a result, the voltage from the voltage source Vcc is impressed on the voltage detecting terminal a through the current-limit resistor 32, so that the potential at the voltage detecting terminal a rises.

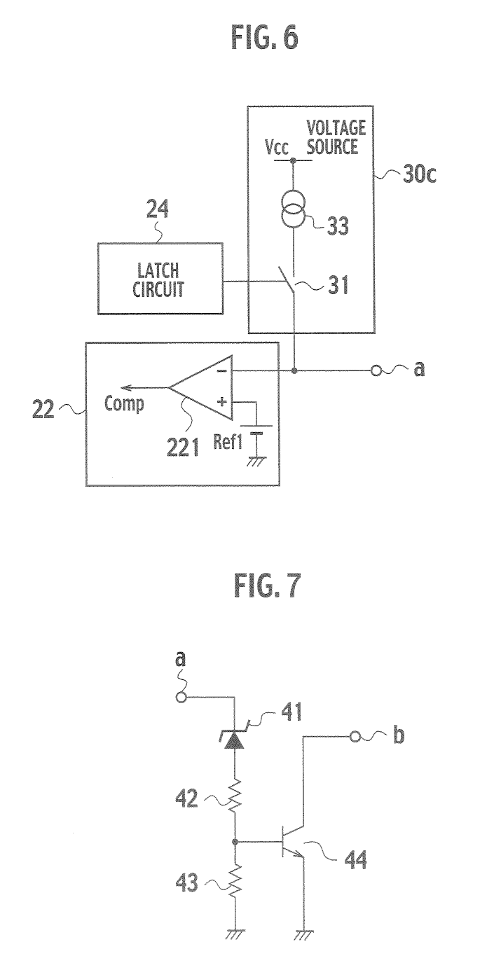

In an abnormal operating signal outputting means 30c shown in FIG. 6, the voltage source Vcc is connected to the voltage detecting terminal a through a constant current source 33 and the switch 31. When the power-factor improvement circuit becomes abnormal, the switch 31 is turned ON on receipt of the latch signal from the latch circuit 24. As a result, the voltage from the voltage source Vcc is impressed on the voltage detecting terminal a through the constant current source 33, so that the potential at the voltage detecting terminal a rises.

Regarding the voltage at the voltage detecting terminal a to be raised as a result of the abnormality in the power-factor improvement circuit, any voltage will do so long as it enables the abnormal signal detecting means 40 to detect a situation different from the normal condition. If only satisfying with discrimination capability dependent on the circuit structure of the abnormal signal detecting means 40, there is no limitation of making a voltage more than the voltage in the normal operating condition by a predetermined extent, a detected overvoltage value or more than the detected overvoltage value.

Owing to the constitutions of FIGS. 4 to 6, if the power-factor improvement circuit becomes abnormal to output the latch signal from the latch circuit 24, then the abnormal operating signal outputting means 30 raises a potential of the voltage detecting terminal a.

Next, detecting that the potential of the voltage detecting terminal a has become the predetermined voltage, the abnormal signal detecting means 40 outputs the abnormal signal to the load circuit 10, thereby informing it of the abnormality in the power-factor improvement circuit.

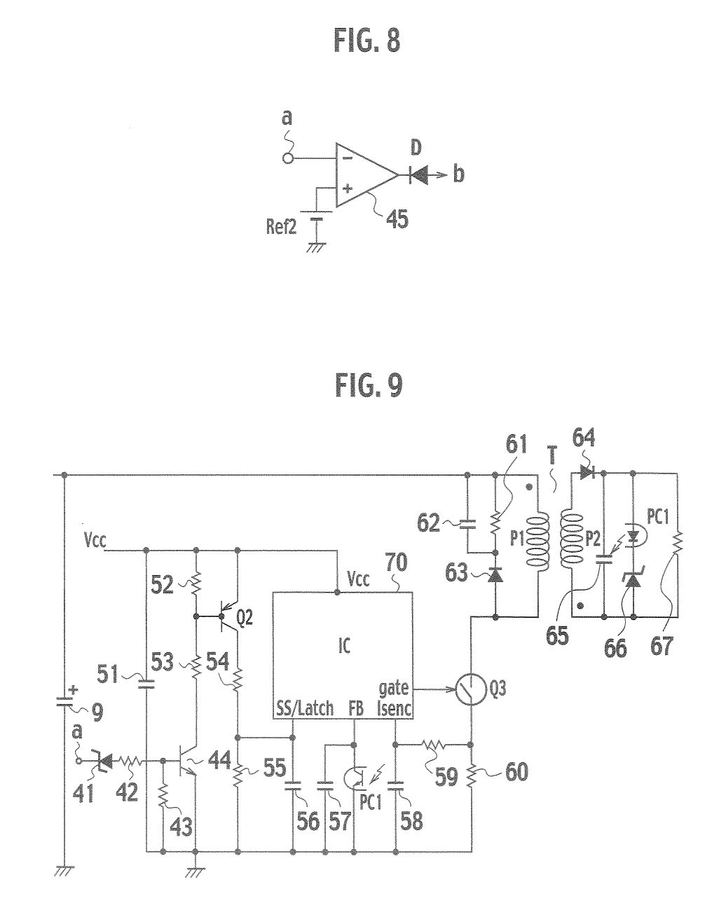

Structural examples of the abnormal signal detecting means 40 are shown in FIGS. 7 and 8. In the abnormal signal detecting means 40 of FIG. 7, a series circuit having a zener diode 41, a resistor 42 and a resistor 43 is connected between the voltage detecting terminal a and the ground. Further, a junction point between the resistor 42 and the resistor 43 is connected to a base of a transistor 44. In the transistor 44, its collector is connected to the load circuit 10 through a terminal b, while the emitter is grounded.

According to the constitution of FIG. 7, when the power-factor improvement circuit becomes abnormal so that the voltage at the voltage detecting terminal a is raised to exceed a yield voltage of the zener diode 41, then it yields. Then, the current flows in the following course of the voltage detecting terminal a, the zener diode 41, the resistor 42, the resistor 43 and the ground, in this order. Therefore the transistor 44 is turned ON, so that the voltage at the collector of the transistor 44 becomes substantially zero (L-level). By this L-level abnormal signal, the load circuit 10 is informed of an occurrence of abnormality in the power-factor improvement circuit. Consequently, the load circuit 10 stops its operation on receipt of the abnormal signal.

While, the abnormal signal detecting means 40 of FIG. 8 is provided with a comparator 45. The comparator 45 has a noninverting terminal connected to the voltage detecting terminal a and an inverting terminal connected to a reference voltage Ref2. On an output side of the comparator 45, its output terminal b is connected to the load circuit 10 through a diode D. The reference voltage Ref2 is preset to be higher than the voltage of the voltage detecting terminal a in the normal condition and also lower than a raised voltage of the voltage detecting terminal a as a result of an abnormality.

According to the constitution of FIG. 8, under the normal condition, the reference voltage Ref2 is higher than the voltage of the voltage detecting terminal a. Therefore, the output of the comparator 45 becomes H-level (high level), for instance. On the contrary, if the power-factor improvement circuit becomes abnormal so that the potential of the voltage detecting terminal a is raised to be higher than the reference voltage Ref2, the output of the comparator 45 is reversed to L-level (low level) In this way by an abnormal signal of L-level, the load circuit 10 is informed of an occurrence of abnormality in the power-factor improvement circuit.

The load circuit 10 monitors an output-voltage detecting terminal through the abnormal signal detecting means 40. When the terminal voltage changes in increase or decrease due to the abnormality in the power-factor improvement circuit, the load circuit 10 stops its operation in safety. For instance, in case of using a DC/DC converter as the load circuit 10, even if the power-factor improvement circuit has an abnormality to stop its operation, the A.C. power source 1 allows D.C. (direct current) voltage to come into being at the smoothing capacitor 9 through the full-wave rectifying circuit 2 and the diode 6. The DC/DC converter could continue to operate by this D.C. voltage. Nevertheless, the DC/DC converter is operationally stopped by an abnormal signal outputted from the abnormal signal detecting means 40.

In the switching power device of FIG. 1 where the abnormal operating signal outputting means 30 and the abnormal signal detecting means 40 are not provided, if the operation of the power-factor improvement circuit stops, the voltage appearing at the smoothing capacitor 9 is reduced normally. As a result, the DC/DC converter operates with low voltage while causing a flowage of great current. Under such a condition, the efficiency of the device would deteriorate. Further, due to heat generation from the components or the like, stress in the components would be increased. If the worst happens, the device might fall into disrepair.

To the contrary, in the present switching power device provided with the abnormal operating signal outputting means 30 and the abnormal signal detecting means 40, the operational stop of the DC/DC converter can be accompanied with the operational stop of the power-factor improvement circuit. Therefore, it is possible to easily provide the switching power device with improved safety.

Further, when the power-factor improvement circuit has an abnormality to raise the potential at the voltage detecting terminal a, the latch circuit 24 holds this state, so that the signal-outputting condition of the abnormal operating detecting means 30 is maintained. When the “load circuit” side in the device stops operationally as a result of receiving the abnormal operating detecting signal from the abnormal operating detecting means 30, the load circuit 10 is not required to hold the stopped condition any longer.

Additionally, since the control circuit 20 consisting of a control IC (integrated circuit) is equipped with the abnormal operating signal outputting means 30 that outputs the abnormal operating signal to the voltage detecting terminal a for the output voltage detecting means 22, it is possible to share the voltage detecting terminal a. In other words, since there is no need to provide an additional terminal for signal, it is unnecessary to modify a package, facilitating addition of functions to the control IC.

Note that the control circuit 20 consisting of the control IC includes a port P1 connected to e.g. the voltage source Vcc, a port P2 connected to the ground, a port P3 connected to the voltage detecting terminal a, a port P4 connected to the full-wave rectifying circuit 2 and a port P5 connected to the current detecting resistor 5. Thus, with the possibility of sharing the port P3, there is no need of increasing the number of ports, accomplishing an integration of circuit with ease.

[Circuit Example of DC/DC Converter]

FIG. 9 is a circuitry diagram of a DC/DC converter that forms a detailed example of the load circuit provided in the switching power device in accordance with one embodiment of the present invention. In FIG. 9, the smoothing capacitor 9 is connected to a series circuit that is composed of a primary winding P1 of a transformer T, a switching element Q3, such as MOSFET, and a resistor 60. A series circuit having a diode 63 and a resistor 61 is connected to both terminals of the primary winding P1 of the transformer T, while a capacitor 62 is connected to the resistor 61 in parallel.

Further, a rectification smoothing circuit composed of a diode 64 and a smoothing capacitor 65 is connected to a secondary winding P2 of the transformer T. This rectification smoothing circuit rectifies and smoothens voltage induced in the transformer T and outputs resultant D.C. voltage to a load 67. A series circuit composed of a photo diode of a photo coupler PC1 and a zener diode 66 is connected to both terminals of the smoothing capacitor 65. When an output voltage for the load 67 becomes more than a yield voltage (reference voltage) of the zener diode 66, the photo diode of the photo coupler PC1 is turned ON. Then, it is carried out to apply the current to a photo transistor in a photo coupler PC1 connected to an integrated circuit (IC) 70 and further narrow a width of each pulse (ON-part) impressed on the switching element Q3, thereby adjusting the output voltage to a constant voltage.

The voltage of the voltage source Vcc is impressed on the IC 70. The IC 70 outputs control signals to a gate of the switching element Q3. As a result, the switching element Q3 is turned ON/OFF to adjust the output voltage to the constant voltage.

Further, between the voltage source Vcc and the ground, there are connected a capacitor 51 and a series circuit having a resistor 52, a resistor 53 and a transistor 44. The transistor 44, the voltage detecting terminal a, the zener diode 41, the resistor 42 and the resistor 43 all constitute the abnormal signal detecting means 40 shown in FIG. 7.

Further, a series circuit having a transistor Q2, a resistor 54 and a resistor 55 is connected between the voltage source Vcc and the ground. The transistor Q2 has its base connected to a joint point between the resistor 52 and the resistor 53. A joint point between the resistor 54 and the resistor 55 is connected to an SS terminal of the IC 70, while a capacitor 56 is connected to the resistor 55 in parallel.

In the DC/DC converter constructed above, when the IC 70 is activated by voltage from the voltage source Vcc, the switching element Q3 is turned ON by the control signal from the IC 70, so that current flows from the smoothing capacitor 9 to the switching element Q3 through the primary winding P1 of the transformer T. This current increases with the passage of time linearly.

Next, the switching element Q3 is changed from its ON state to the OFF state In excitation energy induced in the primary winding P1 of the transformer T, at this time, excitation energy part of leakage inductance is stored in the capacitor 62 through the diode 63. Therefore, voltage resonance is formed by leakage inductance of the primary winding P1 of the transformer T and the capacitor 62, so that the voltage of the switching element Q3 rises.

Note that by adjusting both values of the capacitor 62 and the resistor 61, it is possible to make a ringing waveform at the point of turning OFF the switching element Q3 smaller. Additionally, as the primary winding P1 and the secondary winding P2 are wound in reversed phase to each other, when the switching element Q3 is turned OFF, the current flows in the diode 64, so that the load 67 is supplied with DC voltage.

Here, if an abnormality occurs in the power-factor improvement circuits the abnormal signal detecting means 40 outputs the abnormal signal to the DC/DC converter. That is, when a voltage more than a predetermined voltage is impressed on the voltage detecting terminal a, the transistor 44 is turned ON. Then, current flows in the course of the voltage source Vcc, the resistor 52, the resistor 53, the transistor 44 and the ground, in this order. Consequently, the transistor Q2 is turned ON, so that the current flows in the course of the voltage source Vcc, the transistor Q2, the resistor 54, the resistor 55 and the ground in this order, while the capacitor 56 gets charged. When the voltage at the capacitor 56 rises, the operation of the IC 70 is stopped into its latched condition. At this time, since the IC 70 does not output the control signal to the switching element Q3, the ON/OFF operation of the switching element Q3 is stopped.

As obvious from the above descriptions, according to the present invention, when an abnormality occurs in the switching power device, the detection holding means detects the abnormality, stops the operation of the switching element and holds its stopped condition, while the abnormal operating signal outputting means outputs the abnormal operating signal in the form of voltage more than the predetermined voltage to the voltage detecting terminal on the basis of a holding signal from the detection holding means. Accordingly, it is possible to inform the load circuit of a fact that the switching power device is abnormal.

Additionally, according to the present invention, when an abnormality occurs in the switching power device, the detection holding means stops the operation of the switching element and holds its stopped condition, while the abnormal operating signal outputting means outputs the abnormal operating signal in the form of a voltage more than a predetermined voltage to the voltage detecting terminal on the basis of the holding signal from the detection holding means. Accordingly, it is possible to inform the load circuit of a fact that the power-factor improvement circuit has an abnormality.

Further, according to the present invention, since the control means, the detection holding means and the abnormal operating signal outputting means are all provided in the integrated circuit, while the abnormal operating signal of the abnormal operating signal outputting means is outputted to the voltage detecting terminal for the control means, it is unnecessary to provide an additional terminal for signal. Thus, there is no need of altering the package, facilitating functional addition to the integrated circuit.

Furthermore, according to the present invention, since the operation of the load circuit stops on the ground of the abnormal signal from the abnormal signal detecting means in the power-factor improvement circuit, it is possible to provide the switching power device having improved safety.

### INDUSTRIAL APPLICABILITY

The present invention is applicable to a switching power device, for example DC/DC converter, AC/DC converter or the like.

1. A switching power device configured to convert input voltage into direct-current output voltage with ON/OFF operations of a switching element, comprising:
control means that inputs the output voltage from a voltage detecting terminal thereby turning ON/OFF the switching element on a basis of the output voltage;
detection holding means that detects an abnormality when it occurs in the switching power device to stop an operation of the switching element and that outputs a holding signal while holding a stopped condition of the switching element; and
abnormal operating signal outputting means for outputting an abnormal operating signal in the form of voltage more than a predetermined voltage to the voltage detecting terminal, based on the holding signal from the detection holding means.

2. A power-factor improvement circuit configured to improve a power factor of an alternating-current power source by first inputting rectified voltage, which has been obtained by rectifying alternating-current power voltage of the alternating-current power source with a rectifying circuit, into a series circuit having a reactor and a switching element and secondly turning ON/OFF the switching element, and also configured to provide direct-current output voltage, the power-factor improvement circuit comprising:
control means that inputs the output voltage from a voltage detecting terminal thereby turning ON/OFF the switching element on a basis of the output voltage;
detection holding means that detects an abnormality when it occurs in the switching power device to stop an operation of the switching element and that outputs a holding signal while holding a stopped condition of the switching element; and
abnormal operating signal outputting means for outputting an abnormal operating signal in the form of voltage more than a predetermined voltage to the voltage detecting terminal, based on the holding signal from the detection holding means.

3. The power-factor improvement circuit of claim 2, wherein the control means, the detection holding means and the abnormal signal outputting means are arranged in an integrated circuit.

4. A switching power device having a power-factor improvement circuit and a load circuit connected to the power-factor improvement circuit, the power-factor improvement circuit being configured to improve a power factor of an alternating-current power source by first inputting rectified voltage, which has been obtained by rectifying alternating-current power voltage of the alternating-current power source with a rectifying circuit, into a series circuit having a reactor and a switching element and secondly turning ON/OFF the switching element, and also configured to provide direct-current output voltage, wherein the power-factor improvement circuit comprises:
control means that inputs the output voltage from a voltage detecting terminal thereby turning ON/OFF the switching element on a basis of the output voltage;
detection holding means that detects an abnormality when it occurs in the switching power device to stop an operation of the switching element and that outputs a holding signal while holding a stopped condition of the switching element;
abnormal operating signal outputting means for outputting an abnormal operating signal in the form of voltage more than a predetermined voltage to the voltage detecting terminal on the basis of the holding signal from the detection holding means; and
abnormal signal detecting means configured to output an abnormal signal when detecting, on the basis of the abnormal operating signal from the abnormal operating signal outputting means, that the voltage detecting terminal has reached voltage more than the predetermined voltage.

5. The switching power device of claim 4, wherein the load circuit stops on the basis of the abnormal signal from the abnormal signal detecting means in the power-factor improvement circuit.

6. The switching power device of claim 4, wherein the control means, the detection holding means and the abnormal operating signal outputting means are arranged in an integrated circuit.

7. The switching power device of claim 5, wherein the control means, the detection holding means and the abnormal operating signal outputting means are arranged in an integrated circuit.
